(19) United States
(12) Patent Application Publication
(10) Pub. No.: US 2008/0295716 A1
(43) Pub. Date: Dec. 4, 2008

(54) PRINTING UNIT OF A PRINTING PRESS

(75) Inventors: Peer Dilling, Friedberg (DE); Josef Goettling, Friedberg (DE); Thomas Hartmann, Mering (DE); Guenter Koppelkamm, Neuensalz (DE); Franz-Peter Weissgaerber, Augsburg (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/129,101

(22) Filed: May 29, 2008

(30) Foreign Application Priority Data
May 30, 2007 (DE) 10 2007 025 181.7

(51) Int. Cl. B41F 30/00

(52) U.S. Cl. 101/249

(57) ABSTRACT

A printing unit with at least one plate cylinder and a set-up device, which can be moved from a rest position to the plate cylinder, is disclosed. In order to make good accessibility to the printing couples and to the set-up device possible, the set-up device is arranged in a frame, which can be moved perpendicularly to the axis of rotation of the plate cylinder.

This application claims the priority of German Patent Document No. 10 2007 025 181.7, filed May 30, 2007, the disclosure of which is expressly incorporated by reference herein.

### BACKGROUND AND SUMMARY OF THE INVENTION

The invention relates to a printing unit of a printing press with at least one plate cylinder and a set-up device. The set-up device can be an imaging device or an erasing device for a printing plate or a printing plate changing device.

German Patent Document No. DE 100 13 452 A1 shows a printing couple of a rotary printing press with a plate cylinder and a transfer cylinder, whereby a device for producing a printing plate can be engaged on the plate cylinder. To do so, the device is fastened on an adjustable support that can be used to swivel it from a rest position to the plate cylinder. In addition, the device can be moved into a maintenance position. When used in the case of printing units with printing couple bridges, the device hinders access to the printing couples. In addition, the device is difficult to reach during the set-up process.

The objective of the invention is arranging a set-up device in the case of a printing unit in such a way that good accessibility to the printing couples and to the set-up component is achieved.

Thanks to the arrangement of the set-up component in the frame and thanks to its moveability, access to the printing couples continues to be maintained despite additional functions that have to be taken care of, and the known operating, maintenance and servicing concept can be retained. Maintenance can also be performed on the set-up component during printing.

Additional characteristics and advantages are yielded from the detailed description.

### BRIEF DESCRIPTION OF THE DRAWINGS

The invention shall be explained in greater detail in the following on the basis of several exemplary embodiments. The associated drawings show the following schematically:

FIG. 1 illustrates two printing units arranged side-by-side having printing couple bridges, in which set-up devices are arranged on the plate cylinder;

FIG. 2 illustrates one of the printing units in accordance with FIG. 1, whereby the set-up devices are moved away from the soiled area of the plate cylinder;

FIG. 3 illustrates one of the printing units in accordance with FIG. 1, whereby the set-up devices are moved away from the plate cylinder at a distance that opens up an accessible operating space;

FIG. 4 illustrates a vertical blanket-to-blanket printing unit with set-up devices engaged on the plate cylinders; and

FIG. 5 illustrates a printing unit with web guidance for 2/2 printing.

### DETAILED DESCRIPTION OF THE DRAWINGS

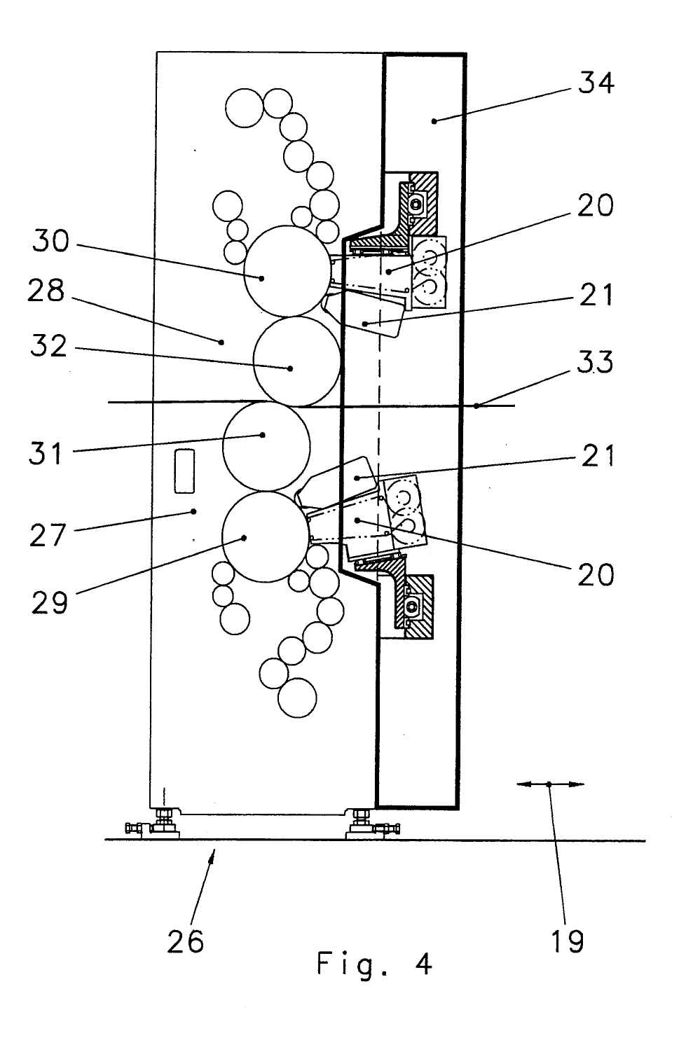

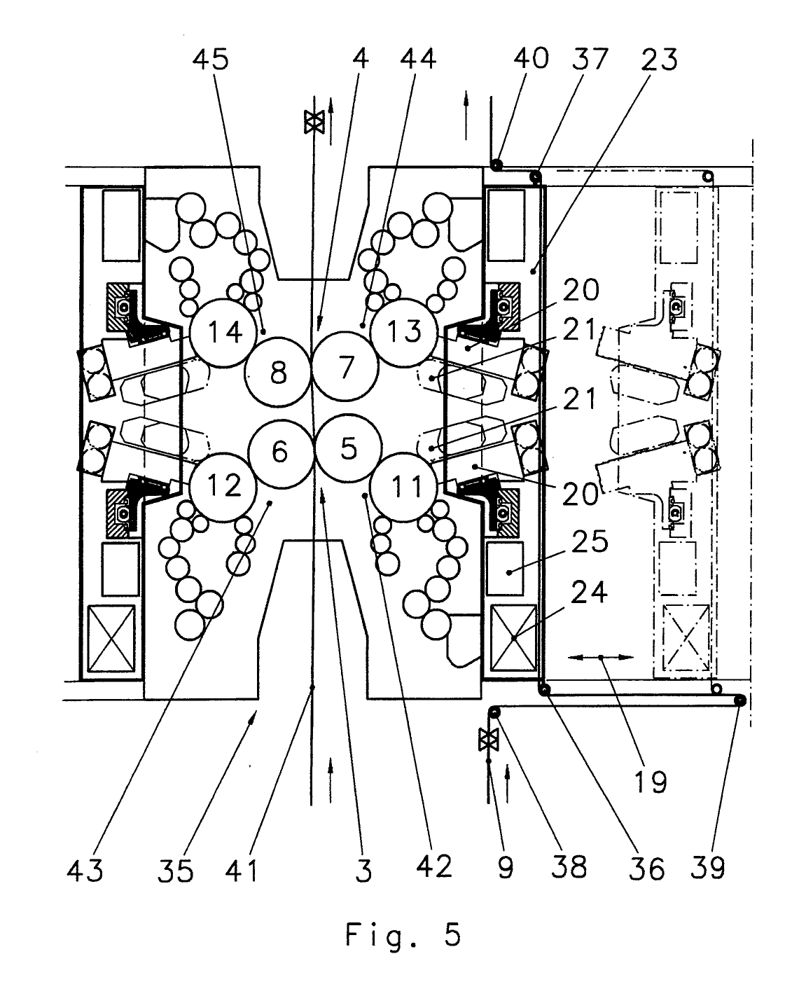

FIG. 1 shows two printing units 1, 2 arranged side-by-side, each containing two stacked printing couple bridges 3, 4. Each printing couple bridge 3, 4 contains two mutually engageable transfer cylinders 5, 6 or 7, 8, between which a web 9 or 10 that is guided through vertically can be printed. A plate cylinder 11 to 14 abuts each transfer cylinder 5 to 8. One plate cylinder and one transfer cylinder 11 and 5, 12 and 6, 13 and 7, 14 and 8 always form a printing couple 42 to 45. The additional components of the printing units 1, 2, such as inking systems and moistening units, are commonly known to those skilled in the art and require no further description to explain the invention. The plate cylinders 11 to 14 and the printing couples 42 to 45 can also belong to a satellite printing unit. These types of satellite printing units are depicted in European Patent Document No. EP 933 200 A1 in FIGS. 4 and 5.

Situated on each access side to the printing couples 42 to 45 of the printing units 1, 2 is a frame 15 to 18, which can be moved in the horizontal direction perpendicularly to the axis of rotation of the plate cylinders 11 to 14. The movement takes place on guides 19, on which the frames 15 to 18 rest or to which they are attached. The guides 19 can be arranged both below as well as above the frames 15 to 18. The guides can also be designed as rails. The movement can take place by means of pneumatic or hydraulic motors or even by means of a threaded spindle drive (threaded spindle and spindle nut). Manual displacement is also possible.

Set-up devices for setting up the plate cylinders 11 to 14 are mounted in each frame 15 to 18. Specifically, for each plate cylinder 11 to 14 this is an imaging device 20 and an erasing device 21. Instead of this, printing plate changing devices 22 (also indicated on frame 15) can also be provided in the frames 15 to 18 for each plate cylinder 11 to 14 or even a printing plate changing device 22 combined with an imaging unit for processless printing plates. The frames 15 to 18 are designed modularly and can contain, in their entirety, part components required for the operation such as electrical control, fluid technology. In the case of the frame 23 in FIG. 5, an electronics cabinet 24 and container 25 for imaging media are shown for example. Alternatively, individual supply components can also be arranged outside the frame 15 to 18.

In terms of the first position of the frame 15 depicted in FIG. 1, the set-up components are engaged in a working position on the plate cylinders 11, 13. In detail, the printing plates located on the plate cylinder 11, 13 are erased with the erasing devices 21 and new print images are being inscribed with the imaging devices 20. The frame 18 is situated in a similar first position on the printing unit 2. These positions of the frames 15 and 18 produce an accessible operating space between them whereby the set-up components can be operated easily.

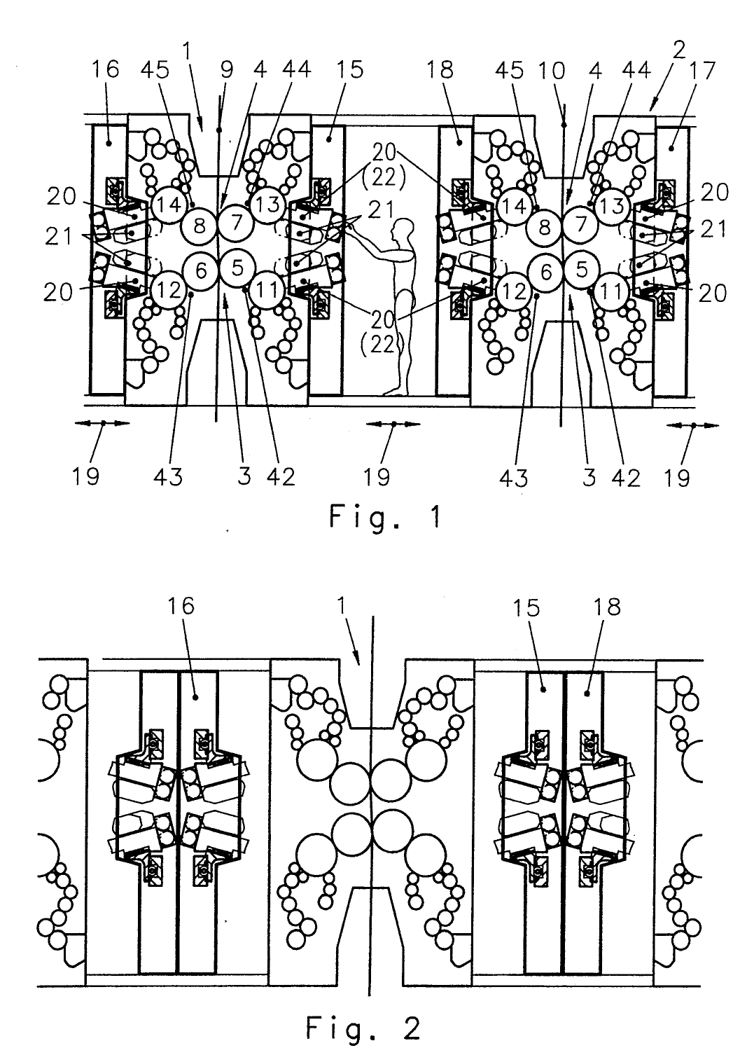

FIG. 2 shows the printing unit 1 according to FIG. 1, wherein its frames 15, 16 are located in a second position, in which the imaging devices 20 and the erasing devices 21 are moved away from the soiled area of the printing unit 1. In such a second position, the frame 18 of the printing unit 2, and the two frames 15 and 18 are thus moved together. In these second positions of the frames 15, 18, maintenance work can also be performed on the set-up devices during printing, for example refilling consumables for the imaging devices 20 and the erasing devices 21.

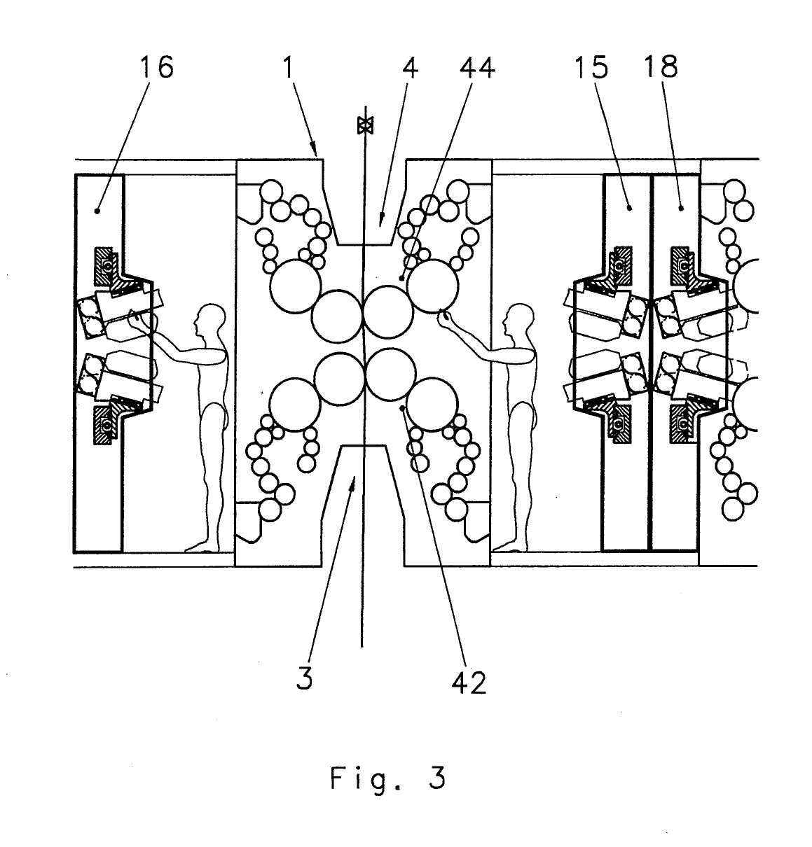

FIG. 3 shows the printing unit 1, in which its frames 15, 16 have been moved away into a third position in which an accessible operating space is opened up between the printing unit 1 and the respective frame 15, 16. Using the accustomed operating concept, the printing couples 42, 44 of the printing couple bridges 3, 4 as well as the set-up components of the frames 15, 16 are accessible from this operating space. To save machine length, the frame 15 is advantageously moved, so it can assume the third position, towards the adjacent frame 18 that has been displaced into the first position. Adjacent frames 15, 18 can therefore be displaced towards one another as needed.

The vertical blanket-to-blanket printing unit 26 depicted in FIG. 4 contains two printing couples 27, 28 each having a plate cylinder 29, 30 and a transfer cylinder 31, 32. A horizontally guided web 33 can be printed in a manner that is known per se when passing through the mutually engaged transfer cylinders 31, 32. A frame 34 containing the set-up devices for each plate cylinder 29, 30 in the form of an imaging device 20 and an erasing device 21 respectively, can be moved in the horizontal direction towards the plate cylinders 29, 30 perpendicularly to their axis of rotation. The first position of the frame 34 is shown, in which the imaging devices 20 and erasing devices 21 are engaged in a working position on the plate cylinders 29, 30. The good accessibility of the set-up devices for operation and maintenance thereof is evident. What is not shown, as was the case with the previous exemplary embodiment, is the frame 34 moveable on guides 19 into a second position, in which the imaging devices 20 and erasing devices 21 are moved away from the soiled area of the vertical blanket-to-blanket printing unit 26, or into a third position, in which an accessible operating space between the vertical blanket-to-blanket printing unit 26 and the frame 34 is opened up.

FIG. 5 shows a printing unit 35, which is similar to the printing unit 1 from FIG. 1 and when placed upon the latter augments it to form an 8-couple tower. The printing unit 35 contains two printing couple bridges 3, 4, whereby the transfer cylinders 5, 6 and the plate cylinders 11, 12 belong to the printing couple bridge 3, and the transfer cylinders 7 and 8 and the plate cylinders 13 and 14 belong to the printing couple bridge 4. One plate cylinder and one transfer cylinder 11 and 5, 12 and 6, 13 and 7, 14 and 8 always form a printing couple 42 to 45. Because of the similarity to the printing unit 1, conforming position numerals were used for the cited components. A frame 23 is assigned to the printing unit 35, which frame contains set-up devices in the form of imaging devices 20 and erasing devices 21, which are engaged in the depicted first position of the frame 23 on the plate cylinders 11 and 13 respectively. The frame 23 supports a guide roller 37, 36 in both the upper and lower region, between which the web 9 that is printed in two-color on both sides in the printing unit 1 is conveyed. In detail, the web 9 that is fed from below via guide rollers 38, 39 is conveyed horizontally to the guide roller 37. In the same sense of direction, the web 9 is then carried away horizontally from the guide roller 37 and diverted vertically upwardly via a further guide roller 40. The web 9 can then be processed further together with a web 41, which was also printed in two-color on both sides after passing through the printing unit 35. This is so-called 2 by 2 web guidance.

The frame 23 can be moved away from the plate cylinders on guides 19 perpendicular to the axis of rotation of the plate cylinders 11, 13. This moved-away position of the frame 23 is indicated by a dotted-and-dashed line in FIG. 5. With this position change of the frame 23, the web that is guided upwardly between the guide rollers 36, 37 that are situated on the frame 23 is offset in a parallel manner, thereby making access to the plate and transfer cylinders 11, 13, 5, 7 of the printing unit 3 possible. In the process, the cut-off compensator of the web 9 is not affected, because the web length between the guide rollers 38 and 40 remains unchanged with the movement of the frame 23 due to the selected arrangement of the guide rollers 36 to 40 in the course of the web 9.

The web guidance shown can also be used advantageously to maintain color register.

The term frame should be understood to mean every type of device, in which the foregoing set-up devices can be accommodated.

### LIST OF REFERENCE NUMERALS

1 Printing unit
2 Printing unit
3 Printing couple bridge
4 Printing couple bridge
5 Transfer cylinder
6 Transfer cylinder
7 Transfer cylinder
8 Transfer cylinder
9 Web
10 Web
11 Plate cylinder
12 Plate cylinder
13 Plate cylinder
14 Plate cylinder
15 Frame
16 Frame
17 Frame
18 Frame
19 Guide
20 Imaging device
21 Erasing device
22 Printing plate changing device
23 Frame
24 Electronics cabinet
25 Container
26 Vertical blanket-to-blanket printing unit
27 Printing couple
28 Printing couple
29 Plate cylinder
30 Plate cylinder
31 Transfer cylinder
32 Transfer cylinder
33 Web
34 Frame
35 Printing unit
36 Guide roller
37 Guide roller
38 Guide roller
39 Guide roller
40 Guide roller
41 Web
42 Printing couple
43 Printing couple
44 Printing couple
45 Printing couple

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing unit, comprising at least two set-up devices arranged in a stacked manner in a frame, wherein the set-up devices are engageable on plate cylinders of two stacked printing couples.

2. The printing unit according to claim 1, wherein the printing couples belong to two stacked printing couple bridges or to a vertical blanket-to-blanket printing unit or to a satellite printing unit.

3. The printing unit according to claim 2, wherein the frame assigned to the two printing couple bridges or to the satellite printing unit supports a guide roller in both an upper and a lower region, between which a web is guided, and wherein the web is conveyable in a same direction as one of the guide rollers and is carried away by the other guide roller.

4. The printing unit according to claim 1, wherein the frame is moveable into a second position, in which the set-up devices are moveable away from a soiled area of the printing unit, or into a third position, in which an accessible operating space between the printing unit and the frame is opened up.

5. The printing unit according to claim 1, wherein the set-up devices include an imaging device.

6. The printing unit according to claim 1, wherein the set-up devices include an erasing device.

7. The printing unit according to claim 1, wherein the set-up devices include a printing plate changing device.

8. A printing unit, comprising:
a first printing couple;
a second printing couple disposed in a vertically stacked manner above the first printing couple;
a first set-up device;
a second set-up device; and
a moveable frame, wherein the first set-up device and the second set-up device are disposed within the frame in a vertically stacked manner and are engageable and disengageable with the first and second printing couples, respectively.

9. The printing unit according to claim 8, wherein the first set-up device and the second set-up device are engageable and disengageable with a plate cylinder of the first and second printing couples.

10. The printing unit according to claim 8, wherein the frame extends vertically along an entire height of the vertically stacked first and second printing couples.

11. The printing unit according to claim 8, wherein the first and second set-up devices are an imaging device.

12. The printing unit according to claim 8, wherein an operator is able to access a side of the frame facing the vertically stacked first and second printing couples and a side of the frame facing away from the vertically stacked first and second printing couples.

13. The printing unit according to claim 8, wherein the frame is moveable in a direction perpendicular to an axis of rotation of the first and second printing couples.

14. The printing unit according to claim 13, wherein the frame is moveable on a guide that is disposed above and below the first and second printing couples.
